(19) United States
(12) Patent Application Publication
(10) Pub. No.: US 2016/0164721 A1
(43) Pub. Date: Jun. 9, 2016

(54) ANOMALY DETECTION IN TIME SERIES DATA USING POST-PROCESSING

(71) Applicant: Google Inc., Mountain View, CA (US)

(72) Inventors: Xinyi ZHANG, San Jose, CA (US); Kevin YU, Palo Alto, CA (US)

(73) Assignee: Google Inc., Mountain View, CA (US)

(21) Appl. No.: 13/826,994

(22) Filed: Mar. 14, 2013

(51) Int. Cl. G06F 15/173

(52) U.S. Cl. CPC H04L 41/0695

(57) ABSTRACT

Described herein are systems, mediums, and methods for detecting anomalies in a signal by applying two analysis algorithms in parallel to the signal. The results of the two algorithms are combined during a post-processing step. The first analysis algorithm detects a first set of anomalies using amplitude-based anomaly detection method. The first set of anomalies includes large dips/spikes with short duration and large week-by-week variations with long duration. The second analysis algorithm detects a second set of anomalies using statistics-based anomaly detection method. The second set of anomalies includes subtle changes with sharp edges and medium duration. The first set of anomalies and the second set of anomalies are merged in a post-processing step. All spikes and all changes that satisfy a pre-determined criteria are removed from the merged data. Adjacent anomalies are concatenated. The resulting set of anomalies is used to determine service outage at a network server.

### BACKGROUND

Many signals derived from real world systems exhibit changes over time. Some of the changes may be anomalous behaviors. An anomaly may correspond to a pattern in the signal that deviates from established normal behavior. Some anomalies may be large dips and/or spikes in the signal with short duration, e.g. as short as one sample. Other anomalies may be subtle changes in the signal with sharp edges and medium duration, e.g. as long as a few samples. It is often desirable to identify all kinds of anomalies in the signal. Traditional algorithms to detect anomalies are challenged to identify extremely small subtle changes in a signal with a large dynamic range and a noticeable trend. Dynamic range of a signal is the ratio between the largest and smallest possible values of the signal.

Systems and methods to detect various types of anomalies in a signal with a large dynamic range and a noticeable trend would therefore be of great benefit in offline data analysis.

### SUMMARY

Accordingly, the systems, mediums and methods described herein include, among other things, detection of an anomaly in a time-series signal and determining service outage at a network server based on the detected anomaly.

According to various embodiments, time series data is received, for example, at a processor. A first anomaly detection algorithm is executed on the received signal to detect a first set of anomalies. A second anomaly detection algorithm is executed on the received signal to detect a second set of anomalies. The first anomaly detection algorithm and the second anomaly detection algorithm may be executed in parallel. The first set of anomalies and the second set of anomalies are combined into a merged set of anomalies. One or more anomalies may be removed from the merged set of anomalies based on a pre-determined criteria. Two or more adjacent anomalies that in a pre-determined proximity in the merged set of anomalies may be concatenated. A service outage at a network server may be determined based on the merged set of anomalies.

The first anomaly detection algorithm may include determining a trend in the received signal. The first anomaly detection algorithm may also include extracting the determined trend from the received signal using empirical mode determination (EMD) method to generate a de-trended signal. A pattern may be estimated in the de-trended signal. The first anomaly detection algorithm may further include detecting the first set of anomalies in the estimated pattern using amplitude-based anomaly detection method.

The second anomaly detection algorithm may include estimating a cyclic pattern in the received signal. The second anomaly detection algorithm may also include extracting the cyclic pattern from the received signal to generate a residual signal. The second anomaly detection algorithm may further include detecting the first set of anomalies in the residual signal using statistics-based anomaly detection method.

### BRIEF DESCRIPTION OF THE DRAWINGS

The accompanying drawings, which are incorporated in and constitute a part of this specification, illustrate one or more embodiments described herein and, together with the description, explain these embodiments. In the drawings:

FIG. 1 depicts an exemplary processor receiving a signal from a signal source for analysis;

FIG. 2A is a flowchart describing exemplary steps performed by the processor in accordance with an exemplary embodiment;

FIG. 2B is a flowchart describing exemplary steps performed by the first anomaly detection algorithm in accordance with an exemplary embodiment;

FIG. 2C is a flowchart describing exemplary steps performed by the second anomaly detection algorithm in accordance with an exemplary embodiment;

FIG. 3 is a flow chart of a method for estimating a nonlinear trend in a signal;

FIG. 4 depicts an exemplary plot illustrating a trend identified in a received signal in accordance with an exemplary embodiment;

FIG. 5 is a flowchart illustrating a pattern extraction method for extracting a cyclic pattern from a signal or segment in accordance with an exemplary embodiment;

FIG. 6 depicts an exemplary plot illustrating an anomaly detected in a segment of the received signal in accordance with an exemplary embodiment;

FIG. 7 depicts an exemplary computing device suitable for use with exemplary embodiments described herein; and

FIG. 8 depicts an exemplary network implementation of processing performed according to an exemplary embodiment.

### DETAILED DESCRIPTION

Embodiments of the present invention concern detecting anomalies in time series data. For example the methods described herein may detect anomalies in a signal representative of network traffic data. The signal being analyzed may have a large dynamic range with a noticeable trend. The dynamic range of the signal is the ratio between the largest and smallest values of the signal. The anomalies may include subtle changes that are extremely small compared to the dynamic range of the received signal. The methods described herein may be used to determine an outage of the network traffic at a network server based in the detected anomalies.

In some exemplary embodiments, two analysis algorithms are applied in parallel to a received signal. The results of the two algorithms are then combined during a post-processing step. The first analysis algorithm detects and extracts a trend from the signal to create a de-trended signal. A pattern, such as a weekly pattern, is then estimated in the de-trended signal. The first analysis algorithm detects a first set of anomalies in the estimated pattern using amplitude-based anomaly detection method. The first set of anomalies may be large dips/spikes with short duration, e.g. as short as one sample, and large, e.g. week-by-week, variations with long duration, e.g. as long as a few hours. The second analysis algorithm, which is run parallel with the first analysis algorithm on the received signal, estimates a cyclic pattern in the received signal. The cyclic pattern is removed from the received signal leaving a residual signal. The second analysis algorithm detects a second set of anomalies in the residual signal using statistics-based anomaly detection method. The second set of anomalies may include subtle changes with sharp edges and medium duration, e.g. as long as a few samples.

In the present application, the results of the first analysis algorithm and the second analysis algorithm, i.e. the first set of detected anomalies and the second set of detected anomalies, are merged in a post-processing step. All spikes may be removed from the merged data. All changes that satisfy a pre-determined criteria may also be removed from the merged data. Adjacent anomalies that are in a pre-determined proximity with each other may be concatenated. The resulting set of anomalies may be used to determine service outage at a network server.

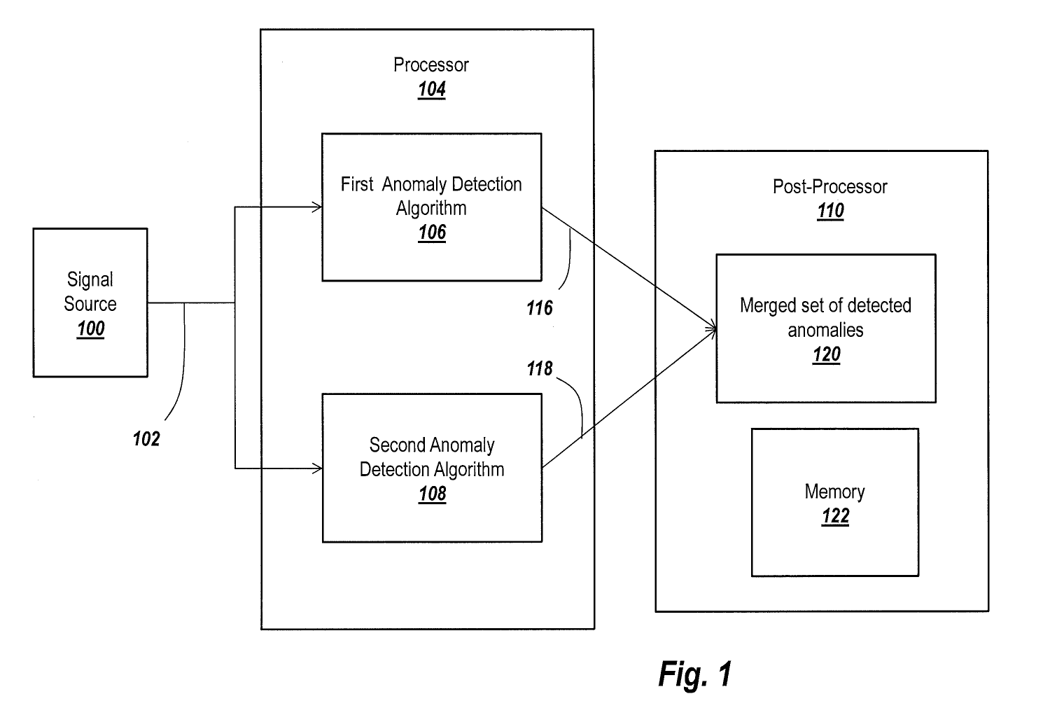

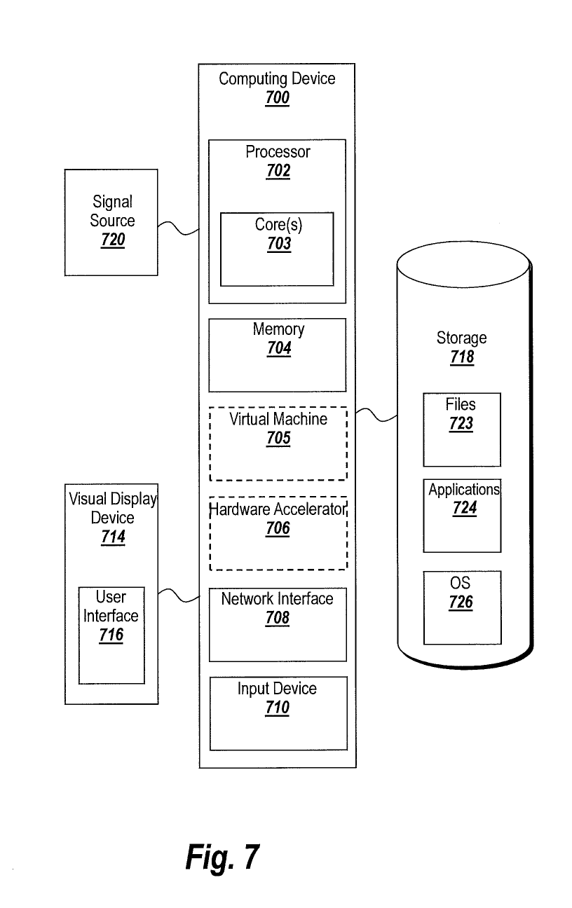

FIG. 1 illustrates an exemplary processor 104. As used herein, the terms “processor” or “computing device” refer to one or more computers, microprocessors, logic devices, servers, or other devices configured with hardware, firmware, and/or software to carry out one or more of the techniques described herein. An illustrative computing device 700, which may be used to implement any of the processors described herein, is described in detail below with reference to FIG. 7.

The processor 104 may receive a signal 102 from a signal source 100. As an example, the signal source 100 may include a device that monitors an amount of traffic flow in a network, and the signal may be a vector of discrete samples corresponding to an amount of traffic flow in the network as a function of time. In an example, the signal 102 may correspond to a number of data packets arriving at a particular node in the network in a given time window such that the signal 102 may represent time series data. The signal source 100 may further be configured to process the signal to get the signal 102 into a certain form, such as by controlling the amplitude of the signal or adjusting other characteristics of the signal. For example, the signal source 100 may quantize, filter, smooth, downsample, upsample, or interpolate the signal, or perform any number of processing techniques on the signal 102. In general, any signal source may be used, if it is desirable to detect anomalies in the provided signal.

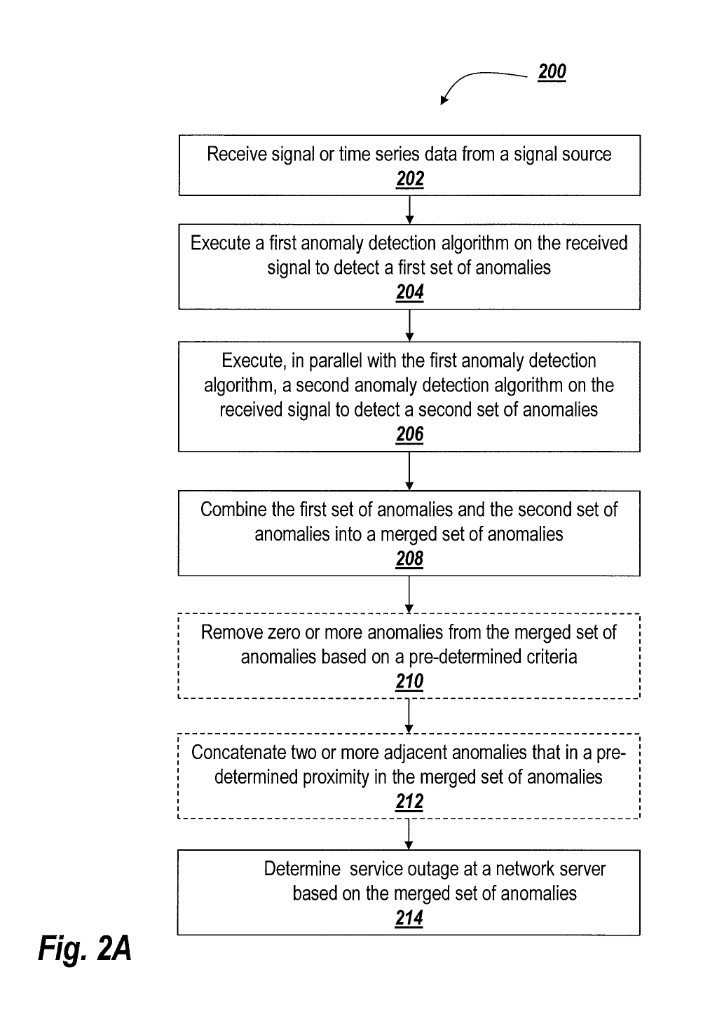

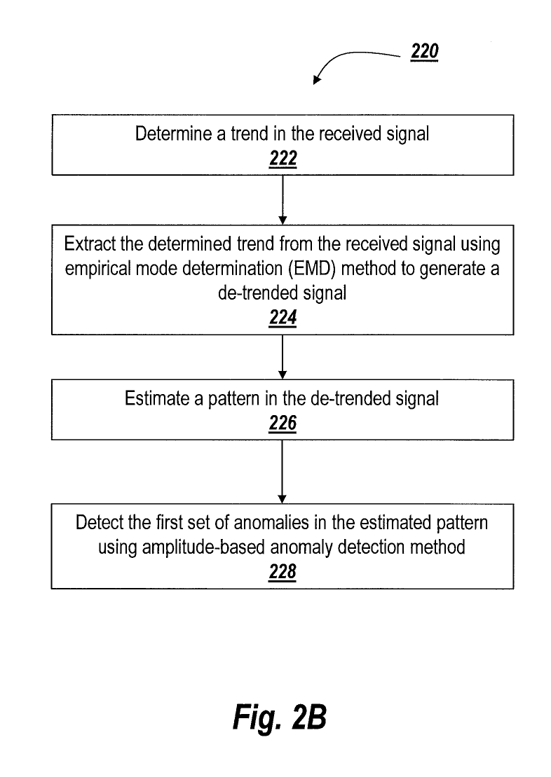

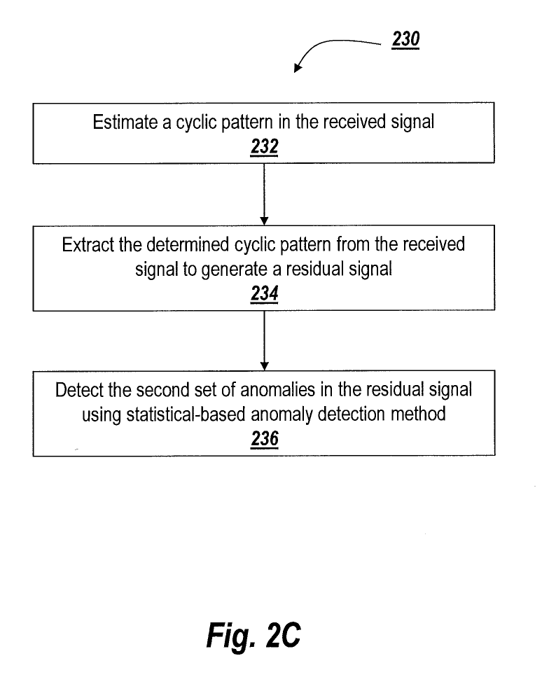

The processor 104 may include a first anomaly detection algorithm 106 and a second anomaly detection algorithm 108. The first anomaly detection algorithm 106 and the second anomaly detection algorithm 108 may process the received signal 102 in parallel. The processing details of the first anomaly detection algorithm 106 and the second anomaly detection algorithm 108 are described in further detail in connection with FIGS. 2B and 2C, respectively.

Upon processing the signal 102, the first anomaly detection algorithm 106 detects a first set of anomalies 116 in the signal 102. The first set of anomalies may be large dips/spikes with short duration, e.g. as short as one sample, and large, e.g. week-by-week, variations with long duration, e.g. as long as a few hours. The first anomaly detection algorithm 106 may detect the first set of anomalies 116 using, for example, an amplitude-based anomaly detection algorithm.

The second anomaly detection algorithm 108 processes the signal 102 in parallel with the first anomaly detection algorithm 106. Upon processing the signal 102, the second anomaly detection algorithm 108 detects a second set of anomalies 118 in the signal 102. The second set of anomalies may include subtle changes with sharp edges and medium duration, e.g. as long as a few samples. The second anomaly detection algorithm 108 may detect the second set of anomalies 118 using, for example, a statistics-based anomaly detection algorithm.

An anomaly, included in the first set of anomalies 116 or the second set of anomalies 118, corresponds to a pattern in the signal 102 that deviates from established normal behavior. Identifying anomalies in a signal is useful for many reasons. For example, the signal 102 received from the signal source 100 may represent an amount of data traffic activity in a network. Network traffic is often bursty, meaning the signal 102 includes unexpected and unpredictable bursts in activity. These traffic bursts may be identified as anomalies in the signal 102 representative of an amount of network traffic over time. Identifying these bursts is important for characterizing activity levels in the network. In an example, the detected anomalies may be indicative of network server outage. Network traffic is just one example of where detection of anomalies may be useful. In general, anomaly detection is useful in a number of fields and may often lead to improved systems in multiple applications.

Once identified, the first set of anomalies 116 and the second set of anomalies 118 are provided to a post-processor 110 for post-processing. The post-processor 110 merges the first set of anomalies 116 and the second set of anomalies 118 into a merged set of detected anomalies 120. The post-processor 110 then removes all spikes from the merged set of detected anomalies 120. The post-processor 110 may also remove one or more changes that fit a pre-determined criteria from the merged set of detected anomalies 120. An exemplary pre-determined criteria may indicate that the anomaly must last a minimum of 5 samples, the deviation of the anomaly from its expected value must be no less than 2% or that the anomaly must be a dip (i.e. all spikes should be filtered out).

In some embodiments, the post-processor 110 may concatenate anomalies that are in close proximity, e.g. adjacent, to each other in the merged set of detected anomalies 120. Based on the resulting anomalies, it may be determined that there has been an outage at the network server. For example, an anomaly detected between 6 AM to 6:10 AM on January 20 may causes a total loss of 100,000 queries at the network during that 10 minutes. A network reliability engineer who analyses this data may collect information around 6 AM on January 20 to see if there is any known issue around that time, e.g. a failed router, an erroneous network configuration, etc.

FIG. 2A is a flowchart describing a method 200 performed by the processor in accordance with an exemplary embodiment. At step 202, the processor receives the signal or times series data from a signal source. At step 204, the first anomaly detection algorithm is executed on the received signal to detect a first set of anomalies. The details of detecting the first set of anomalies are discussed below in detail in connection with FIG. 2B. At step 206, the second anomaly detection algorithm is executed on the received signal to detect a second set of anomalies. The details of detecting the second set of anomalies are discussed below in detail in connection with FIG. 2C. The first anomaly detection algorithm and the second anomaly detection algorithm may be executed on the received signal in parallel. At step, 208, the first set of anomalies and the second set of anomalies are combined into a merged set of anomalies at a post-processor.

At step 210, the post-processor may remove zero or more anomalies from the merged set of anomalies based on a pre-determined criteria. That is, anomalies that does not qualify significant anomalies based on the pre-determined criteria may be removed from the merged set of anomalies. For example, the post-processor may remove all anomalies that are deemed insignificant in magnitude, as defined by the user. For example, if the first set of anomalies may include 20 anomalies and the second set of anomalies may include 10 anomalies. By merging the two sets of anomalies, 30 anomalies may be identified in total. Each individual anomaly may be analyzed using the pre-determined criteria. Based on the analysis, it may be determined that 18 anomalies among the identified 30 anomalies are not significant enough, i.e. does not qualify as anomalies based on the pre-determined criteria. Accordingly, 18 anomalies may be removed from the identified 30 anomalies, leaving 12 anomalies for further analysis. However, if all 30 anomalies are determined to qualify as significant anomalies based on the pre-determined criteria, no anomalies are removed from the merged set. Alternatively, if all 30 anomalies are determined to be insignificant changes based on the pre-determined criteria, all anomalies are removed from the merged set.

At optional step 212, the post-processor may concatenate two or more adjacent anomalies that in a pre-determined proximity in the merged set of anomalies. Based on the remaining anomalies in the merged set of anomalies, a service outage at a network server may be detected.

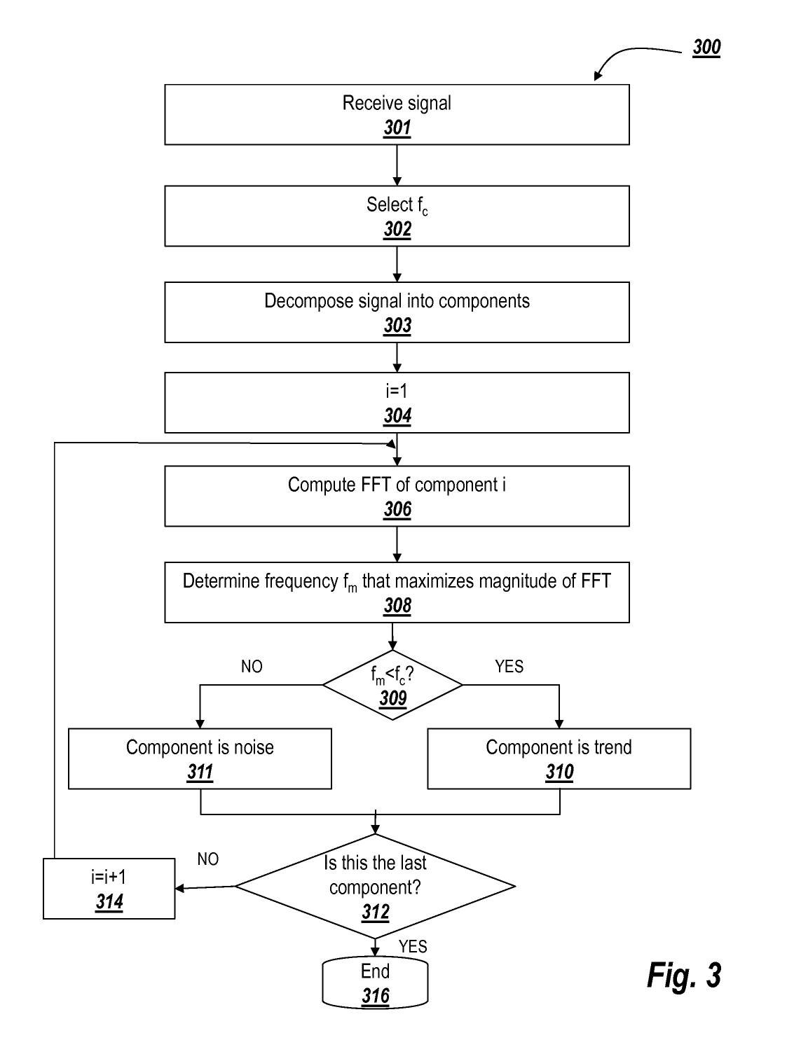

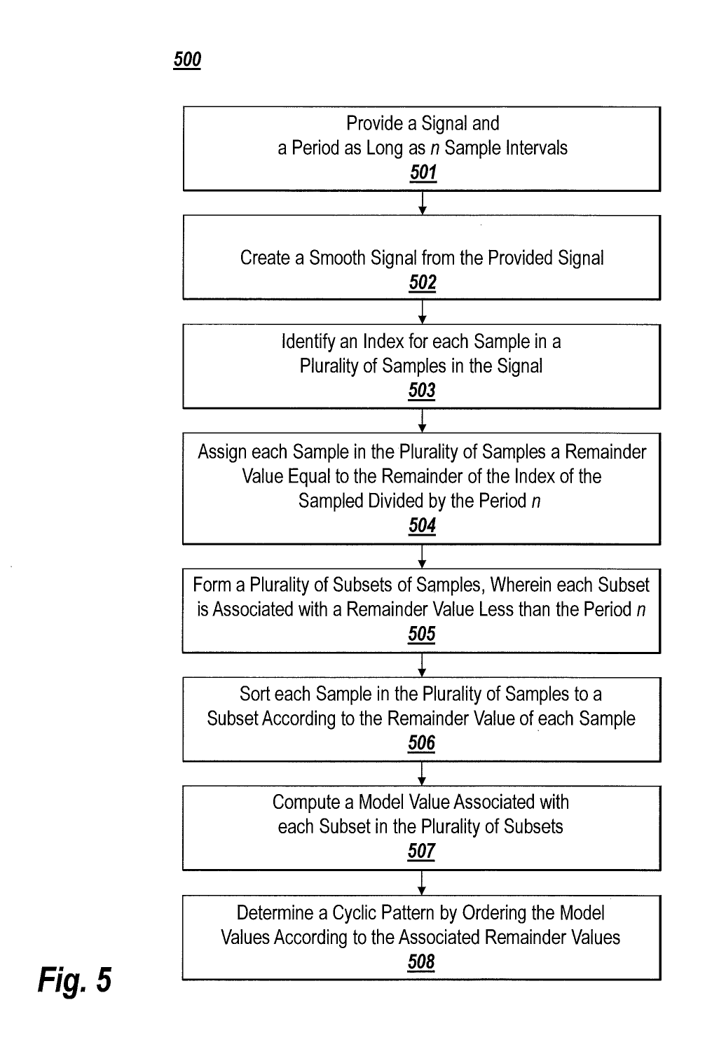

FIG. 2B is a flowchart describing a method 220 for identifying the first set of anomalies. The received signal may exhibit relatively long-term, slow-changing trend that is hidden by faster changing noise. A trend is representative of long-term fluctuations corresponding to slow changes (i.e., increases and decreases) in the signal. For example, in a signal representing network traffic data over one day, higher traffic during the daytime and lower traffic at night may constitute a trend. However, if the signal represents network data over a longer time period such as a year, a trend may occur, for example, over several months. At step 222, the first anomaly detection algorithm determines a trend in the received signal. At step 224, the first anomaly detection algorithm extracts the determined trend from the received signal using, for example, empirical mode determination (EMD) method to generate a de-trended signal. The details of determining and extracting a trend in a signal are discussed below in detail in connection with FIG. 3. At step 226, the first anomaly detection algorithm estimates a cyclic pattern, such as a weekly pattern, in the de-trended signal. For example, in a signal representing network traffic data over one day, there may be higher traffic during the daytime and lower traffic at night. Over a period of days or months, the increased traffic in daytime may appear as a cyclic data pattern. A cyclic pattern can be observed in a signal if enough periodic measurements are taken to capture two or more occurrences of the cycling data pattern. The details of estimating a cyclic pattern in a signal are discussed below in detail in connection with FIG. 5. At step 228, the first anomaly detection algorithm detects the first set of anomalies in the estimated pattern using amplitude-based anomaly detection method.

In particular, amplitude-based anomaly detection method generates a historical probability distribution of the signal 102 based on previously received samples. Samples in the signal 102 correspond to amounts of data flow in a network within a time interval. For each sample in a plurality of samples in the signal 102, a likelihood is computed based at least in part on the historical probability distribution. A likelihood threshold is selected, and a set of consecutive samples is identified as an anomaly when each sample in the set has a computed likelihood below the likelihood threshold. That is, the amplitude-based anomaly detection algorithm 106 detects an anomaly that corresponds to at least one sample in the signal 102 having a likelihood value below a likelihood threshold. The amplitude-based anomaly detection is described in detail in U.S. patent application Ser. No. 13/480,084, which is incorporated herein in entirety by reference.

FIG. 2C is a flowchart describing a method 230 for identifying the second set of anomalies. At step 232, the second anomaly detection algorithm estimates a cyclic pattern in the received signal. The second anomaly detection algorithm may set the cyclic pattern size to be equal to the input data size. The details of estimating a cyclic pattern in a signal are discussed below in detail in connection with FIG. 5. At step 234, the second anomaly detection algorithm extracts the determined cyclic pattern from the received signal to generate a residual signal. At step 236, the second anomaly detection algorithm detects the second set of anomalies in the estimated pattern using statistics-based anomaly detection method.

In particular, statistics-based anomaly detection method determines a range of signal sample values based on one or more estimated statistics of the signal 102. For example, the range may correspond to a number of standard deviations away from a mean of the sample values, and values that fall outside the range may be identified as anomalies. The amplitude-based anomaly detection algorithm generates a sequence of likelihoods corresponding to the sample values in the signal 102. The likelihoods are based at least in part on a historical probability distribution of previously received sample values, and a likelihood is a probability of occurrence of a corresponding sample value in the signal 102. Likelihood change points are identified in the likelihood sequence, and the signal 102 is segmented into a plurality of segments at samples corresponding to the identified change points. A segment is identified as an anomaly based on a comparison between a statistic of the segment and a statistic of the historical probability distribution. The statistics-based anomaly detection is described in detail in U.S. patent application Ser. No. 13/569,688. which is incorporated herein in entirety by reference.

The following describes the details of determining and extracting a trend in a signal.

FIG. 3 is a flow chart of a method 300 used by the first anomaly detection algorithm 106 for estimating a nonlinear trend in a signal. The method 300 begins with the steps of receiving a signal (step 301), selecting a cut-off frequency parameter fe (step 302), decomposing the signal into multiple components (step 303), and initializing an iteration parameter i to one (step 304). The Fourier transform of a first component is computed (step 306), and a frequency fm corresponding to the maximum magnitude of the Fourier transform is determined (step 308). Then, iffm is less than fe, the first component is categorized as a trend component (step 309). Otherwise, the first component is categorized as a noise component (step 311). The steps 328-236 are repeated until all components have been considered and are categorized as either trend or noise components, and the method ends (step 316).

First, at step 301, the first anomaly detection algorithm 106 receives the signal 102 from the signal source 100. As described in relation to FIG. 1, the signal may be representative of an amount of traffic flow in a network, such as a number of data packets that arrive at a location within a particular time window.

At step 302, the first anomaly detection algorithm 106 selects a cut-off frequency parameter fc. The parameter fc corresponds to a threshold frequency value for identifying trend components and noise components in the signal 102. In particular, the signal 102 may be subdivided into multiple signal components, and one or more signal components may be identified as a trend component or a noise component based on a comparison between a frequency in the signal component and the cut-off frequency fc. The frequency in the signal component may be selected to be a frequency with a maximum magnitude in a frequency representation of the signal component. In this case, the frequency in the signal component may be a primary or a fundamental frequency of the signal component. For example, if the frequency in the signal component is below fe, the signal component may be identified as a trend component; otherwise, the signal component may be identified as a noise component.

The first anomaly detection algorithm 106 may select the cut-off frequency fc in a number of ways. In an example, the first anomaly detection algorithm 106 selects fc based on a user input. In this case, the user input may be precisely fe, or the first anomaly detection algorithm 106 may process the user input to derive an appropriate value for fc. For example, the user input may include some information about the signal, such as expected primary frequency components that should be included in the final trend estimate. Thus, the first anomaly detection algorithm 106 may select an appropriate value for fc by selecting a frequency above the range of frequencies specified by the user. In some examples, it may be desirable to use different values of fc for different types of signals, such as lower fc for signals with slow variations and higher fc for signals with faster variations. This information may be supplied by a user or determined separately by the first anomaly detection algorithm 106. Any suitable method of determining a cut-off frequency fc may be used.

At step 303, the signal 102 is decomposed into multiple signal components. This signal decomposition can occur in a number of ways, and one such example is using empirical mode decomposition (EMD), which breaks the signal down into signal components in the time domain. Because the analysis is performed in the time-domain, instantaneous frequency changes in the signal and phase information are preserved. In addition, temporal features, such as points in time at which certain changes to the signal occur, are also preserved. The signal components have the same length as the signal, and the superposition of all the signal components results in the signal. The EMD method is described in detail in U.S. patent application Ser. No. 13/483,601, which is incorporated herein in entirety by reference, However, any suitable method of decomposing a signal, such as Fourier transforms and wavelet decomposition methods, may also be used.

At step 304, an iteration parameter i is initialized to one, and at step 306, a Fourier transform of the ith signal component is computed. The Fourier transform may be computed using known techniques such as the Fast Fourier Transform (FFT). The FFT transforms the signal component in the time domain to a representation in a frequency domain by providing a sequence of complex values, each representative of a magnitude and phase of a different frequency component in the signal component. In addition, the ith signal component may be processed (e.g., by filtering or any other sort of processing) before and/or after the Fourier transform is computed. Any suitable transform may be computed (e.g., wavelet transforms or any other transform).

At step 308, the first anomaly detection algorithm 106 determines the frequency fm that corresponds to a frequency component with maximum magnitude in the Fourier transform. The frequency fm represents a primary or fundamental frequency component in the signal component. For example, the frequency fm can be the global maximum or a local maximum. In another example, the frequency fm may be required to satisfy some criteria, such as the maximum frequency within a range of frequencies. In some signal components, there may be more than one frequency component with the same maximal magnitude. In this case, the first anomaly detection algorithm 106 may select as fm the component with the lowest frequency, another component, or may perform some processing on the components such as taking the average.

At decision block 309, the first anomaly detection algorithm 106 compares fm and fc to determine whether fc exceeds m. In an example, the decision block 309 may include a more stringent condition such as requiring that fc exceed fm by a threshold amount before determining that fc sufficiently exceeds fm. The frequency fm represents a primary frequency in the signal component, and the first anomaly detection algorithm 106 identifies a signal component as trend or noise based on its primary frequency. Because a trend of a signal corresponds to long-term fluctuations in the signal 102, identifying the trend may require removing high frequency portions of the signal 102. By sorting the signal components into trend and noise categories, the first anomaly detection algorithm 106 selects signal components including primarily low frequencies as trend components and signal components including primarily high frequencies as noise components.

At step 310, upon determining that fc exceeds fm (or some other criteria is satisfied by the relationship between fc and fm), the first anomaly detection algorithm 106 identifies or categorizes the ith signal component as a trend component. Thus, signal components with primary frequency components that are less than the cut-off frequency fc are categorized as trend components. As an example this categorization may be performed by setting a flag parameter corresponding to the ith component to a value indicative of a trend component.

At step 311, upon determining that fm exceeds fc (or some other criteria is satisfied by the relationship between fc and fm), the first anomaly detection algorithm 106 categorizes the ith signal component as a noise component.

At decision block 312, the first anomaly detection algorithm 106 determines whether the ith is the last component. If not, the iteration parameter i is incremented, and the processor 106 repeats steps 306-312. Otherwise, when all signal components have been considered, the method ends at step 316.

The method 300 illustrates parsing the signal components in a particular order. For example, when the signal is decomposed using empirical mode decomposition at step 303, the value of the iteration parameter i may correspond to the ith signal component. However, any order of the signal components may be used, such as a reverse order or a random order.

Furthermore, in some embodiments, not every signal component is examined using steps 306-312. For example, when empirical mode decomposition is used to decompose the signal 102 into multiple signal components at step 303, the last signal component is typically not zero mean, and may sometimes be automatically categorized as trend.

In some embodiments, a metric may be used to assess the confidence of a category. This confidence metric may be useful for determining which categories are more certain to be accurate than others. For example, for a signal component for which fm greatly exceeds fe, a metric indicating a high confidence may be assigned indicating that the signal component is noise, compared to another signal component for which fm barely exceeds fc. In addition, signal components corresponding to low confidence (i.e., signal components for which fm is within some threshold range near fc) may be categorized as neither trend nor noise.

In some embodiments, the first anomaly detection algorithm 106 may not select a value for fc prior to performing the signal decomposition at step 303. For example, the signal 102 may first be decomposed such that a primary frequency of the signal components may be determined before selecting a value for fc. In this case, the value for fc may be determined based on the set of primary frequencies. For example, it may be desirable to identify only a fixed number (e.g., 3) of signal components as trend, such that fc may be appropriately chosen to be between the two primary frequencies (e.g., corresponding to the signal components with the third and fourth lowest primary frequencies). In this case, the first anomaly detection algorithm 106 ensures that only the fixed number of signal components are categorized as trend.

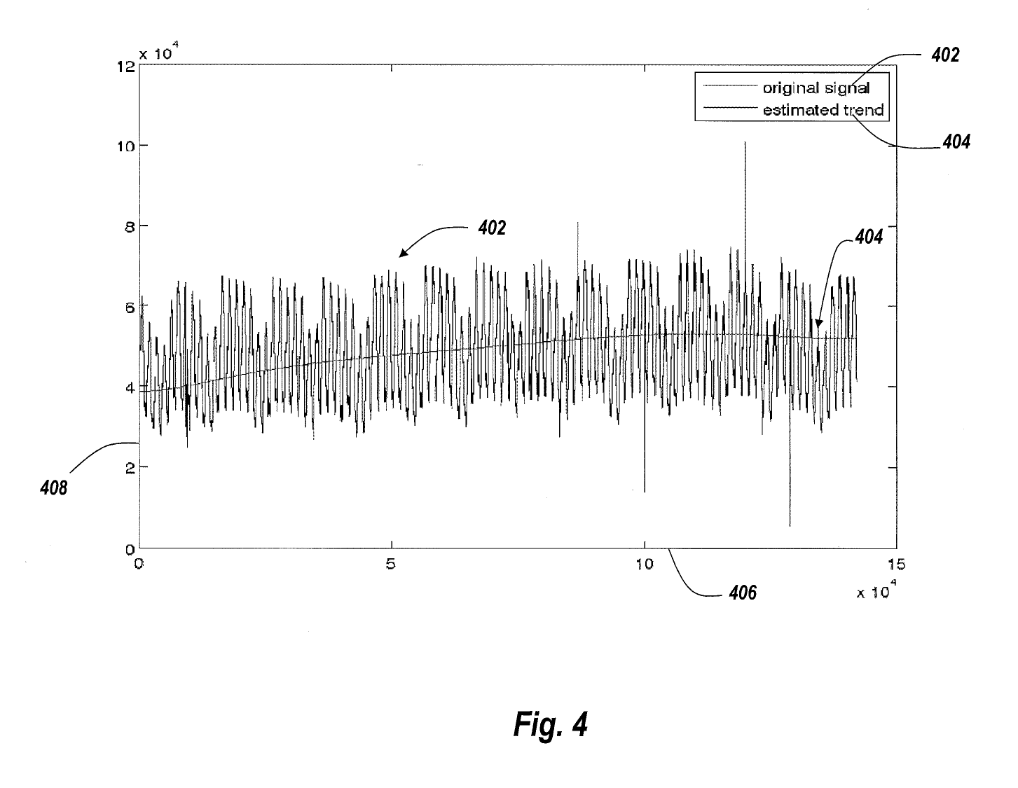

FIG. 4 illustrates an estimated trend 404 identified in a received signal 402. As illustrated in FIG. 4, the received signal 402 has a large dynamic range and a noticeable trend. The received signal 402 may be graphically illustrated using a plot showing the amount of samples 408 at given time stamps 406. Applying the method described above in connection with FIG. 3, the estimated trend 404 may be identified in the received signal 402.

The following describes the details of determining and extracting a cyclic pattern from a signal.

FIG. 5 is a flowchart illustrating a pattern extraction method 500 for extracting a cyclic pattern from a signal or segment. According to various embodiments, the signal maybe de-trended and smoothed using de-trending and smoothing techniques described in detail in U.S. patent application Ser. Nos. 13/446,842; 13/463,601 and 13/488,875, which are incorporated herein in entirety by reference.

The illustrative pattern extraction method 500 begins when a signal and a period as long as an integer n number of samples is provided in step 501. In step 502, a smoothed signal is created from the signal. The pattern extraction method 500 may then proceed to identify the data that will be used to determine the value of the cyclic pattern during each sampling interval of the period.

In step 503, an index is identified for each sample in a plurality of samples in the smoothed signal. In step 504, each sample is assigned a remainder value equal to the remainder of the index of the sample divided by n. As an illustrative example, consider a cyclic pattern with a period of one day in a signal consisting of one sample taken per hour for a calendar year. In this example, although a sample taken at midnight on January 1 would have an index of zero and a sample taken at midnight on January 3 would have an index of 48, both samples would have a remainder value of zero.

In step 505, a plurality of subsets of samples is formed in memory 112, with each subset associated with a remainder value less than n. In step 506, each sample in the plurality of samples is sorted to a subset according to the remainder value of each sample. In the illustrative example given above, a sample taken at midnight would be sorted into a subset associated with a remainder value of zero, regardless of whether the sample was taken on the first or the last day of the year; similarly, a sample taken at 3 PM would be sorted into a subset associated with a remainder value of 15. The plurality of subsets is then ready to serve as the basis for determining the cyclic pattern. In step 507, a model value associated with each subset in the plurality of subsets is computed. Step 508 orders the model values according to the associated remainder values, determining the cyclic pattern. In the illustrative example given above, the cyclic pattern for the first hour of a day might equal the average of all samples taken at midnight, the average of all samples taken at 1 AM for the second hour of a day, and so on.

As each model value is calculated from the available data associated with a remainder value, each model value is data-driven. As a model value is calculated for each remainder value, the cyclic pattern is determined for a time resolution equal to the sampling interval. Cyclic pattern extraction method 500 therefore does not use distorting assumptions on what the cyclic pattern may be, nor does method 500 determine a cyclic pattern with lower resolution than the signal in which the cyclic pattern is found.

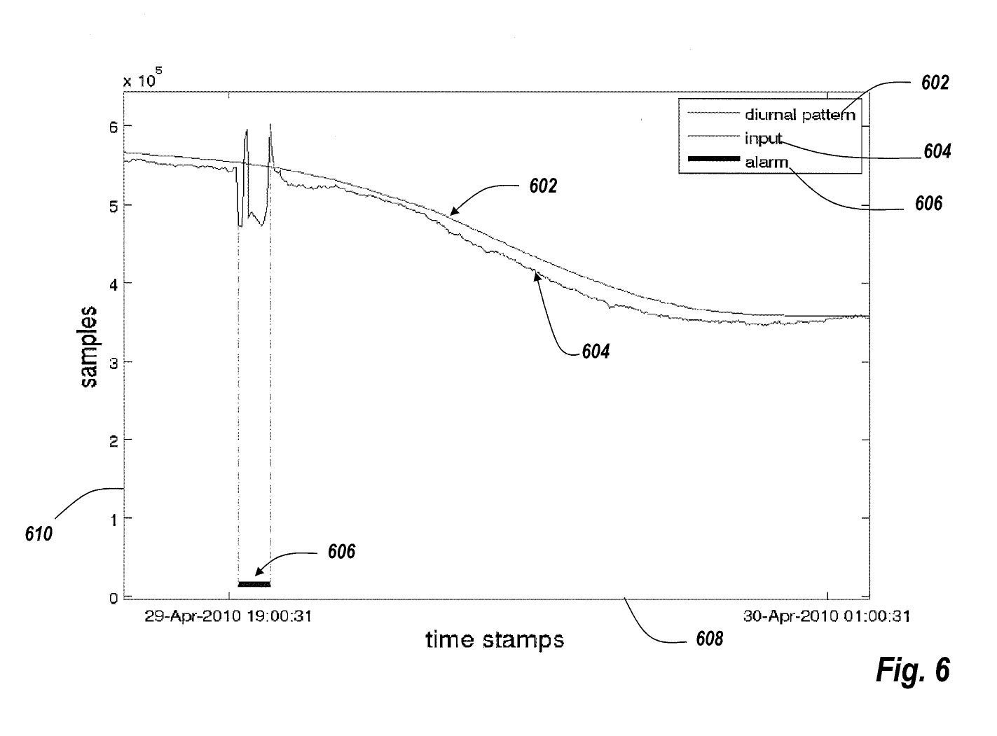

FIG. 6 illustrates a cyclic pattern 602 extracted from a signal 604 of the received signal. The signal 604 of the received signal may be graphically illustrated using a plot showing the amount of samples 610 at given time stamps 608. Applying the methods described above in connection with FIG. 5, a cyclic pattern such as a diurnal pattern 602 may be identified and extracted from the signal 604. The anomaly detection logic 108 may process the residual signal (i.e., the difference between the signal 604 and the cyclic pattern 602) to detect the anomaly 606 using a statistics-based anomaly detection algorithm. In particular, statistics-based anomaly detection method determines a range of signal sample values based on one or more estimated statistics of the signal 604. For example, the range may correspond to a number of standard deviations away from a mean of the sample values, and values that fall outside the range may be identified as anomalies. The statistics-based anomaly detection is described in detail in U.S. patent application Ser. No. 13/569,688, which is incorporated herein in entirety by reference.

One or more of the above-described acts may be encoded as computer-executable instructions executable by processing logic. The computer-executable instructions may be stored on one or more non-transitory computer readable media. One or more of the above described acts may be performed in a suitably-programmed electronic device. FIG. 7 depicts an example of an electronic device 700 that may be suitable for use with one or more acts disclosed herein.

The electronic device 700 may take many forms, including but not limited to a computer, workstation, server, network computer, quantum computer, optical computer, Internet appliance, mobile device, a pager, a tablet computer, a smart sensor, application specific processing device, etc.

The electronic device 700 is illustrative and may take other forms. For example, an alternative implementation of the electronic device 700 may have fewer components, more components, or components that are in a configuration that differs from the configuration of FIG. 7. The components of FIG. 7 and/or other figures described herein may be implemented using hardware based logic, software based logic and/or logic that is a combination of hardware and software based logic (e.g., hybrid logic); therefore, components illustrated in FIG. 7 and/or other figures are not limited to a specific type of logic.

The processor 702 may include hardware based logic or a combination of hardware based logic and software to execute instructions on behalf of the electronic device 700. The processor 702 may include logic that may interpret, execute, and/or otherwise process information contained in, for example, the memory 704. The information may include computer-executable instructions and/or data that may implement one or more embodiments of the invention. The processor 702 may comprise a variety of homogeneous or heterogeneous hardware. The hardware may include, for example, some combination of one or more processors, microprocessors, field programmable gate arrays (FPGAs), application specific instruction set processors (ASIPs), application specific integrated circuits (ASICs), complex programmable logic devices (CPLDs), graphics processing units (GPUs), or other types of processing logic that may interpret, execute, manipulate, and/or otherwise process the information. The processor may include a single core or multiple cores 703. Moreover, the processor 702 may include a system-on-chip (SoC) or system-in-package (SiP).

The electronic device 700 may include one or more tangible non-transitory computer-readable storage media for storing one or more computer-executable instructions or software that may implement one or more embodiments of the invention. The non-transitory computer-readable storage media may be, for example, the memory 704 or the storage 718. The memory 704 may comprise a ternary content addressable memory (TCAM) and/or a RAM that may include RAM devices that may store the information. The RAM devices may be volatile or non-volatile and may include, for example, one or more DRAM devices, flash memory devices, SRAM devices, zero-capacitor RAM (ZRAM) devices, twin transistor RAM (TTRAM) devices, read-only memory (ROM) devices, ferroelectric RAM (FeRAM) devices, magneto-resistive RAM (MRAM) devices, phase change memory RAM (PRAM) devices, or other types of RAM devices.

One or more computing devices 700 may include a virtual machine (VM) 705 for executing the instructions loaded in the memory 704. A virtual machine 705 may be provided to handle a process running on multiple processors so that the process may appear to be using only one computing resource rather than multiple computing resources. Virtualization may be employed in the electronic device 700 so that infrastructure and resources in the electronic device may be shared dynamically. Multiple VMs 705 may be resident on a single computing device 700.

A hardware accelerator 706, may be implemented in an ASIC, FPGA, or some other device. The hardware accelerator 706 may be used to reduce the general processing time of the electronic device 700.

The electronic device 700 may include a network interface 708 to interface to a Local Area Network (LAN), Wide Area Network (WAN) or the Internet through a variety of connections including, but not limited to, standard telephone lines, LAN or WAN links (e.g., T1, T3, 76kb, X.25), broadband connections (e.g., integrated services digital network (ISDN), Frame Relay, asynchronous transfer mode (ATM), wireless connections (e.g., 802.11), high-speed interconnects (e.g., InfiniBand, gigabit Ethernet, Myrinet) or some combination of any or all of the above. The network interface 708 may include a built-in network adapter, network interface card, personal computer memory card international association (PCMCIA) network card, card bus network adapter, wireless network adapter, universal serial bus (USB) network adapter, modem or any other device suitable for interfacing the electronic device 700 to any type of network capable of communication and performing the operations described herein.

The electronic device 700 may include one or more input devices 710, such as a keyboard, a multi-point touch interface, a pointing device (e.g., a mouse), a gyroscope, an accelerometer, a haptic device, a tactile device, a neural device, a microphone, or a camera that may be used to receive input from, for example, a user. Note that electronic device 700 may include other suitable I/O peripherals.

The input devices 710 may allow a user to provide input that is registered on a visual display device 714. A graphical user interface (GUI) 716 may be shown on the display device 714.

A storage device 718 may also be associated with the computer 700. The storage device 718 may be accessible to the processor 702 via an I/O bus. The information may be executed, interpreted, manipulated, and/or otherwise processed by the processor 702. The storage device 718 may include, for example, a storage device, such as a magnetic disk, optical disk (e.g., CD-ROM, DVD player), random-access memory (RAM) disk, tape unit, and/or flash drive. The information may be stored on one or more non-transient tangible computer-readable media contained in the storage device. This media may include, for example, magnetic discs, optical discs, magnetic tape, and/or memory devices (e.g., flash memory devices, static RAM (SRAM) devices, dynamic RAM (DRAM) devices, or other memory devices). The information may include data and/or computer-executable instructions that may implement one or more embodiments of the invention

The storage device 718 may further store applications 724, and the electronic device 700 can be running an operating system (OS) 726. Examples of OS 726 may include the Microsoft® Windows® operating systems, the Unix and Linux operating systems, the MacOS® for Macintosh computers, an embedded operating system, such as the Symbian OS, a real-time operating system, an open source operating system, a proprietary operating system, operating systems for mobile electronic devices, or other operating system capable of running on the electronic device and performing the operations described herein. The operating system may be running in native mode or emulated mode.

One or more embodiments of the invention may be implemented using computer-executable instructions and/or data that may be embodied on one or more non-transitory tangible computer-readable mediums. The mediums may be, but are not limited to, a hard disk, a compact disc, a digital versatile disc, a flash memory card, a Programmable Read Only Memory (PROM), a Random Access Memory (RAM), a Read Only Memory (ROM), Magnetoresistive Random Access Memory (MRAM), a magnetic tape, or other computer-readable media.

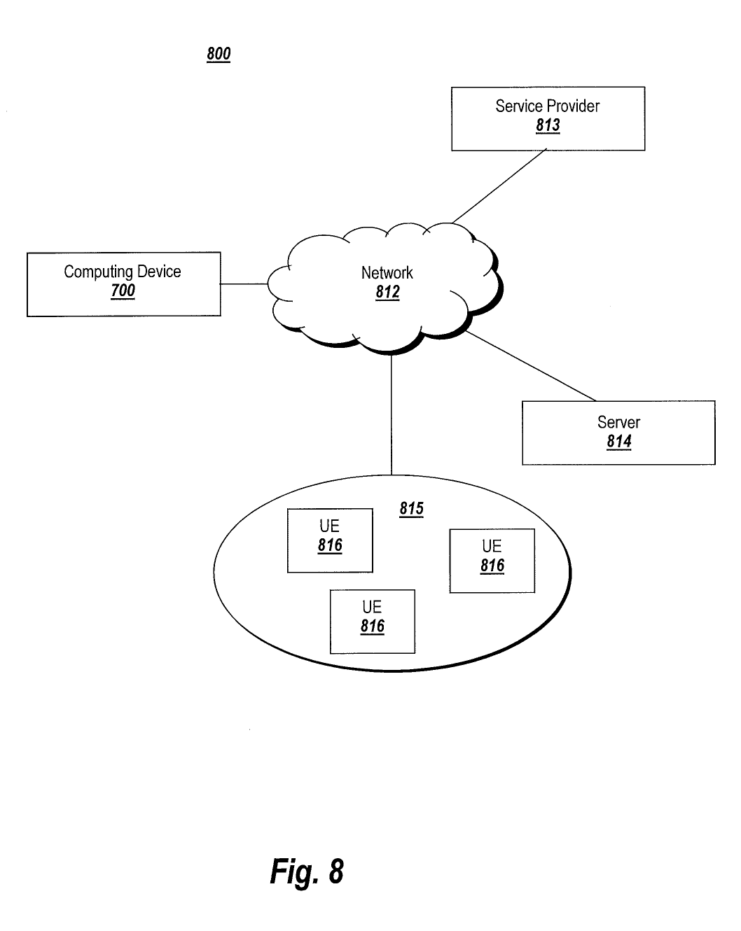

FIG. 8 depicts a network implementation that may implement one or more embodiments of the invention. A system 800 may include a computing device 700, a network 812, a service provider 813, a target environment 814, and a cluster 815. The embodiment of FIG. 8 is exemplary, and other embodiments can include more devices, fewer devices, or devices in arrangements that differ from the arrangement of FIG. 8.

The network 812 may transport data from a source to a destination. Embodiments of the network 812 may use network devices, such as routers, switches, firewalls, and/or servers (not shown) and connections (e.g., links) to transport data. Data may refer to any type of machine-readable information having substantially any format that may be adapted for use in one or more networks and/or with one or more devices (e.g., the computing device 700, the service provider 813, etc.). Data may include digital information or analog information. Data may further be packetized and/or non-packetized.

The network 812 may be a hardwired network using wired conductors and/or optical fibers and/or may be a wireless network using free-space optical, radio frequency (RF), and/or acoustic transmission paths. In one implementation, the network 812 may be a substantially open public network, such as the Internet. In another implementation, the network 812 may be a more restricted network, such as a corporate virtual network. The network 812 may include Internet, intranet, Local Area Network (LAN), Wide Area Network (WAN), Metropolitan Area Network (MAN), wireless network (e.g., using IEEE 802.11), or other type of network The network 812 may use middleware, such as Common Object Request Broker Architecture (CORBA) or Distributed Component Object Model (DCOM). Implementations of networks and/or devices operating on networks described herein are not limited to, for example, any particular data type, protocol, and/or architecture/configuration.

The service provider 813 may include a device that makes a service available to another device. For example, the service provider 813 may include an entity (e.g., an individual, a corporation, an educational institution, a government agency, etc.) that provides one or more services to a destination using a server and/or other devices. Services may include instructions that are executed by a destination to perform an operation (e.g., an optimization operation). Alternatively, a service may include instructions that are executed on behalf of a destination to perform an operation on the destination's behalf.

The server 814 may include a device that receives information over the network 812. For example, the server 814 may be a device that receives user input from the computer 700.

The cluster 815 may include a number of units of execution (UEs) 816 and may perform processing on behalf of the computer 700 and/or another device, such as the service provider 813 or server 814. For example, the cluster 815 may perform parallel processing on an operation received from the computer 700. The cluster 815 may include UEs 816 that reside on a single device or chip or that reside on a number of devices or chips.

The units of execution (UEs) 816 may include processing devices that perform operations on behalf of a device, such as a requesting device. A UE may be a microprocessor, field programmable gate array (FPGA), and/or another type of processing device. UE 816 may include code, such as code for an operating environment. For example, a UE may run a portion of an operating environment that pertains to parallel processing activities. The service provider 813 may operate the cluster 815 and may provide interactive optimization capabilities to the computer 700 on a subscription basis (e.g., via a web service).

Units of Execution (UEs) may provide remote/distributed processing capabilities for the applications 824. A hardware unit of execution may include a device (e.g., a hardware resource) that may perform and/or participate in parallel programming activities. For example, a hardware unit of execution may perform and/or participate in parallel programming activities in response to a request and/or a task it has received (e.g., received directly or via a proxy). A hardware unit of execution may perform and/or participate in substantially any type of parallel programming (e.g., task, data, stream processing, etc.) using one or more devices. For example, a hardware unit of execution may include a single processing device that includes multiple cores or a number of processors. A hardware unit of execution may also be a programmable device, such as a field programmable gate array (FPGA), an application specific integrated circuit (ASIC), a digital signal processor (DSP), or other programmable device. Devices used in a hardware unit of execution may be arranged in many different configurations (or topologies), such as a grid, ring, star, or other configuration. A hardware unit of execution may support one or more threads (or processes) when performing processing operations.

A software unit of execution may include a software resource (e.g., a technical computing environment) that may perform and/or participate in one or more parallel programming activities. A software unit of execution may perform and/or participate in one or more parallel programming activities in response to a receipt of a program and/or one or more portions of the program. A software unit of execution may perform and/or participate in different types of parallel programming using one or more hardware units of execution. A software unit of execution may support one or more threads and/or processes when performing processing operations.

The foregoing description may provide illustration and description of various embodiments of the invention, but is not intended to be exhaustive or to limit the invention to the precise form disclosed. Modifications and variations may be possible in light of the above teachings or may be acquired from practice of the invention. For example, while a series of acts has been described above, the order of the acts may be modified in other implementations consistent with the principles of the invention. Further, non-dependent acts may be performed in parallel.

In addition, one or more implementations consistent with principles of the invention may be implemented using one or more devices and/or configurations other than those illustrated in the Figures and described in the Specification without departing from the spirit of the invention. One or more devices and/or components may be added and/or removed from the implementations of the figures depending on specific deployments and/or applications. Also, one or more disclosed implementations may not be limited to a specific combination of hardware.

Furthermore, certain portions of the invention may be implemented as logic that may perform one or more functions. This logic may include hardware, such as hardwired logic, an application-specific integrated circuit, a field programmable gate array, a microprocessor, software, or a combination of hardware and software.

No element, act, or instruction used in the description of the invention should be construed critical or essential to the invention unless explicitly described as such.

Also, as used herein, the article “a” is intended to include one or more items. Where only one item is intended, the term “a single” or similar language is used. Further, the phrase “based on,” as used herein is intended to mean “based, at least in part, on” unless explicitly stated otherwise. In addition, the term “user”, as used herein, is intended to be broadly interpreted to include, for example, an electronic device (e.g., a workstation) or a user of an electronic device, unless otherwise stated.

It is intended that the invention not be limited to the particular embodiments disclosed above, but that the invention will include any and all particular embodiments and equivalents falling within the scope of the following appended claims.

1. A non-transitory electronic device readable storage medium storing instructions for detecting network service outages that, when executed, cause one or more processors to:
receive a network traffic signal in form of time series data from a network server;
execute an amplitude-based anomaly detection algorithm on the received network traffic signal to detect a first set of anomalies from a first set of samples of the received network traffic signal;
execute a statistics-based anomaly detection algorithm on the received network traffic signal to detect a second set of anomalies from a second set of samples of the received network traffic signal, wherein the amplitude-based anomaly detection algorithm and the statistics-based anomaly detection algorithm are executed in parallel;
combine the first set of anomalies and the second set of anomalies into a merged set of anomalies; and
determine that there is a service outage at the network server based on a number of anomalies in the merged set of anomalies being above a predefined threshold and within a predefined time window.

2. (canceled)

3. The medium of claim 1, further storing instructions that, when executed, cause one or more processors to:
remove zero or more anomalies from the merged set of anomalies based on a pre-determined criteria.

4. The medium of claim 3, wherein one or more spikes are removed from the merged set of anomalies.

5. The medium of claim 3, wherein one or more changes are removed from the merged set of anomalies.

6. The medium of claim 1, further storing instructions that, when executed, cause one or more processors to:
concatenate two or more adjacent anomalies that in a pre-determined proximity in the merged set of anomalies.

7. The medium of claim 1, wherein executing the first anomaly detection algorithm further executes instructions that cause one or more processors to:
determine a trend in the received signal;
extract the determined trend from the received signal using empirical mode determination (EMD) method to generate a de-trended signal; and
estimate a pattern in the de-trended signal.

8. The medium of claim 7, wherein the estimated pattern is a weekly pattern.

9. The medium of claim 1, wherein executing the second anomaly detection algorithm further executes instructions that cause one or more processors to:
estimate a cyclic pattern in the received signal; and
extract the cyclic pattern from the received signal to generate a residual signal.

10. The medium of claim 9, wherein the cyclic pattern is a repetitive periodic feature occurring in the received data.

11. An apparatus for detecting network service outages, comprising:
a processor that:
receives a network traffic signal in form of time series data from a network server; and
executes:
an amplitude-based anomaly detection logic on the network traffic signal for detecting a first set of anomalies from a first set of samples of the received network traffic signal, and
a statistics-based anomaly detection logic on the network traffic signal to detect a second set of anomalies from a second set of samples of the received network traffic signal, wherein the amplitude-based anomaly detection logic and the statistics-based anomaly detection logic are executed in parallel; and
a post-processor executing one or more instructions to:
combine the first set of anomalies and the second set of anomalies into a merged set of anomalies, and
determine that there is a service outage at the network server based on a number of anomalies in the merged set of anomalies being above a predefined threshold and within a predefined time window.

12. The system of claim 11, wherein the post-processor further executes one or more instructions to:
remove zero or more anomalies from the merged set of anomalies based on a pre-determined criteria.

13. The system of claim 11, wherein the post-processor further executes one or more instructions to:
concatenate two or more adjacent anomalies that in a pre-determined proximity in the merged set of anomalies.

14. The system of claim 11, wherein executing the first anomaly detection algorithm further comprises:
determining a trend in the received signal;
extracting the determined trend from the received signal using empirical mode determination (EMD) method to generate a de-trended signal; and
estimating a pattern in the de-trended signal.

15. The system of claim 11, wherein executing the second anomaly detection algorithm further comprises:
estimating a cyclic pattern in the received signal;
extracting the cyclic pattern from the received signal to generate a residual signal;
detecting the first set of anomalies in the residual signal using statistics-based anomaly detection method.

16. A computer-implemented method of detecting network service outages comprising:
receiving, using a computing device, a network traffic signal in form of time series data from a network server;
executing an amplitude-based anomaly detection algorithm on the received network traffic signal to detect a first set of anomalies from a first set of samples of the received network traffic;
executing a statistics-based anomaly detection algorithm on the received signal to detect a second set of anomalies from a second set of samples of the received network traffic, wherein the amplitude-based anomaly detection algorithm and the statistics-based anomaly detection algorithm are executed in parallel;
combining the first set of anomalies and the second set of anomalies into a merged set of anomalies; and
determining that there is a service outage at the network server based on a number of anomalies in the merged set of anomalies being above a predefined threshold and within a predefined time window.

17. The method of claim 16, further comprising:
remove zero or more anomalies from the merged set of anomalies based on a pre-determined criteria.

18. The method of claim 16, further comprising:
concatenate two or more adjacent anomalies that in a pre-determined proximity in the merged set of anomalies.

19. The method of claim 16, wherein executing the first anomaly detection algorithm further comprises:
determining a trend in the received signal;
extracting the determined trend from the received signal using empirical mode determination (EMD) method to generate a de-trended signal; and
estimating a pattern in the de-trended signal.

20. The method of claim 16, wherein executing the second anomaly detection algorithm further comprises:
estimating a cyclic pattern in the received signal; and
extracting the cyclic pattern from the received signal to generate a residual signal.
